(19) United States
(12) Patent Application Publication
(10) Pub. No.: US 2006/0146013 A1
(43) Pub. Date: Jul. 6, 2006

(54) Electronic device with virtual image display

(76) Inventors: Theodore R. Arneson, Ivanhoe, IL (US); John C. Neumann, Chicago, IL (US); Michael L. Charlier, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 11/028,412

(22) Filed: Jan. 4, 2005

(51) Int. Cl. G09G 5/00

(52) U.S. Cl. 345/156

(57) ABSTRACT

An electronic device (100) has a first body (110) with an image generation apparatus (140) and an optical system (150); and, a display element (105) for providing a virtual image moveably attached to the first body (110) such that the display element (105) is capable of moving in at least one plane relative to the first body (110). Another embodiment relates to a mobile communications device (300) with a first body (305) having an image generation apparatus and an optical system; a second body (310) having a liquid crystal display (350) moveably attached to the first body (305); and, a display element (315) for providing a virtual image moveably attached to the first body (305) such that the display element (315) is capable of moving in at least one plane relative to the first body (305).

### CROSS REFERENCE TO RELATED APPLICATIONS

This application is related to the following U.S. patent applications:
“Foldable Electronic Device with Virtual Image Display” (Attorney Docket No. CS25637RL) by Theodore R. Arneson, David E. Devries, John C. Neumann, and Michael L. Charlier; and
“System and Method for Automatic Display Switching” (Attorney Docket No. CS25638RL) by Theodore R. Arneson, Michael L. Charlier, and John C. Neumann.

All of the related applications are filed on even date herewith, are assigned to the assignee of the present application, and are hereby incorporated herein in their entirety by this reference thereto.

### FIELD OF THE INVENTION

The present invention relates to electronic devices with displays.

### BACKGROUND OF THE INVENTION

Electronic devices such as mobile phones are known to have various design features including a display. There is a growing need for users of electronic devices to receive files, pictures and contents from the Internet or other sources. Since many pictures and files have large display screen requirements, it is difficult to recognize and capture all the information with the display provided by the liquid crystal display (LCD) panels of mobile phones.

There is a need for an improved electronic device, which can provide images with a larger field-of-view to allow users to view images and files from the Internet or another source. Additionally, such electronic devices need to be physically designed to be user-friendly and enable a user to view such images even as the user performs other functions on these electronic devices.

### BRIEF DESCRIPTION OF THE FIGURES

The accompanying figures together with the detailed description below are incorporated in and form part of the specification, serve to further illustrate various embodiments and to explain various principles and advantages all in accordance with the present invention.

FIG. 1 shows an electronic device with a virtual image display element according to a first embodiment.

FIG. 2 shows an electronic device with a virtual image display element according to a second embodiment.

FIG. 3 shows a mobile communications device having two bodies and a virtual display element according to a third embodiment.

FIG. 4 depicts a user using the mobile communications device of FIG. 3 to view a virtual display.

FIG. 5 shows a flowchart depicting a method of virtual image generation in an electronic device.

### DETAILED DESCRIPTION

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and shall not be limited by the embodiments shown below.

It is further understood that the use of relational term, if any, such as first, second, top and bottom, front and rear and the like are used solely for distinguishing one entity or action from another, without necessarily requiring or implying any such actual relationship or order between such entities or actions. Much of the inventive functionality and many of the inventive principles are best implemented with electronic and optical devices and equipment. It is expected that one of ordinary skill, notwithstanding possibly significant effort and many design choices, when guided by the concepts and principles disclosed herein will be readily capable of generating such electronic devices with minimal experimentation. Therefore, in the interest if brevity and minimization of any risk of obscuring the principles and concepts according to the present invention, further discussion of such electronic device, if any, will be limited to the essentials with respect to the principles and concepts within the preferred embodiments.

Improvements in technology have made it possible to achieve high-speed data transmission rates. Therefore data, such as multimedia, requiring high-speed data transmission rates can be transmitted across a network without noticeable delay. This makes it possible to view high-resolution multimedia data, on an electronic device, including a mobile phone. However, in the case of electronic devices such as mobile phones, the size of the electronic device is a major constraint that limits the display area. Considering the rate at which mobile phones and such other electronic devices are being increasingly used to access the web or any such similar service, there is a need to harmonize two conflicting needs of having a small display size and at the same time providing a higher resolution image viewing facility. High-resolution multimedia could be displayed by providing a display with an increased Field of View (field-of-view). Several methods have been proposed to obtain a larger field-of-view, such as utilizing a magnifying telescope inside the substrate, or utilizing prism magnifiers, etc. However, the field-of-view can only be improved to a limited extent with these methods and usually with disadvantages in terms of size and weight.

An electronic device has a display element for providing a virtual image, such that the display element is capable of moving in at least one plane relative to a first body of the electronic device. Thus, the electronic device is capable of providing a virtual image with a large field-of-view through a display element, which can move and rotate with respect to the first body of the device, enabling the user to use the display while performing other functions on the device. An embodiment relates to a portable communications device having a body with an image generation apparatus and an optical system, and a display element for providing a virtual image with a large field of view, such that the display element is capable of moving in at least one plane relative to the first body. Thus, a user can enjoy an electronic device with a virtual image display or a display element providing better quality images, a larger field of view, and ease of use while being able to view the virtual image in various positions, and maintaining a desirable size of the device. Furthermore, the display element can be protected by the portable communication device when not in use. Additionally, the display element can be viewed in multiple orientations and therefore suits both left-handed and right-handed users.

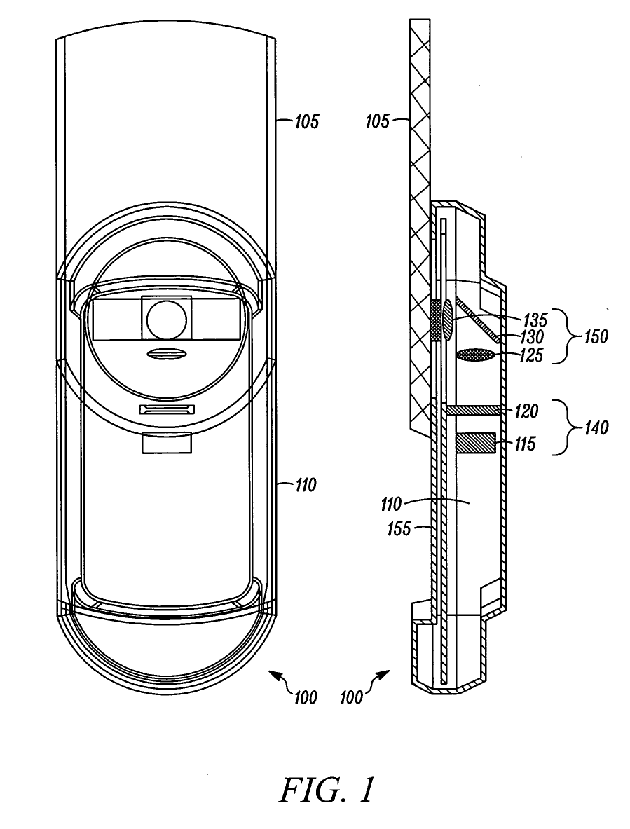

According to FIG. 1, a first embodiment of an electronic device 100 includes a display element 105 and a first body 110. In this embodiment, the electronic device 100 is a mobile communications device, but it could be another type of electronic device such a video game, personal digital assistant (PDA), laptop computer, vehicle navigation system, etc. The electronic device 100 has a first body 110 containing an image generation apparatus 140 and an optical system 150; and a display element 105 to provide a virtual image, moveably attached to the first body 110, such that the display element 105 is capable of moving in at least one plane parallel to the first body 110.

According to an embodiment, the display element 105 is a substrate guided optical element. The substrate guided optical element enables the projection of the virtual image with a larger field of view, while still controlling the thickness of the element. The substrate guided optical element as developed by Lumus, is a flat and small transparent body that can be reduced to the size of an eyeglass lens. This technology facilitates very compact, personal, screen-less, high-resolution and high-brightness image displays. When combined with a microdisplay source, it projects a high-quality image directly into the eye of a user. Although the projecting element is small, a large image is viewed through it. When combined with a microdisplay in the first body 110, the substrate guided optical element projects a high-quality image directly into the eye of a user. Though the virtual image is viewed at a near-to-eye distance, the substrate guided optical element allows a larger field-of-view, and yet results in a 40% reduction in the device volume, when compared to conventional optics such as optical wave guides. Another advantage of using the light guided optical element technology and the like is a reduction of cost due to lower requirements of optical components.

According to an embodiment, the display element 105 is made of a transparent material, such as glass or plastic. This feature provides an interesting design feature because the display material is transparent and other features of the first body 110 below the display element 105 are thus visible. In one embodiment, the display element 105 is enclosed in a frame (not shown) made of non-transparent material. In the embodiment shown, the display element 105 is frameless.

The image generation apparatus 140 has a microdisplay 120 with a backlight 115 that brightens the image produced by the microdisplay 120. A LCD can be substituted for the microdisplay 120. The backlight 115 illuminates the real image produced by the microdisplay 120 and beams the real image through the converging lens 125. The converging lens 125 manipulates the image by magnifying or reducing it and directs it to a reflector 130 that is placed in front of the converging lens 125, which further directs the image to a collimator 135, which makes the light rays of the real image parallel to each other. These parallel rays are directed from the first body 110, which provides the virtual image in the display element 105. In an embodiment, the reflector 130 is a surface of a prism.

According to this embodiment, the display element 105 is disposed such that the display element 105 can slide in a plane parallel with the first body 110 as shown in FIG. 1. As shown, the display element 105 is capable of movement along a track 155 as shown. The display element is shown to have already moved relative to the first body 110 to a predetermined opened position.

The electronic device further has a switch (not shown), which enables the image generation apparatus 140 when the display element 105 has reached at least one predetermined position relative to the first body 110. The predetermined position of the display element 105 is a position with respect to the first body 110 that facilitates image generation in the display element 105. When the display element 105 reaches the predetermined position, the image generated by the microdisplay 120 reaches the reflector 130 and the collimator 135 due to the predetermined positions of the optical system 150, and is displayed on the display element 105. The significance of the predetermined position is that if the first body 110 and the display element 105 are misaligned, the light rays of the real image would not be properly incident into the display element 105. The switch (not shown) disables the image generation apparatus 140 when the display element 105 is not in the predetermined position relative to the first body 110. Disabling the image generation apparatus 140 limits unnecessary use of the microdisplay, reduces power consumption, and also prevents the microdisplay 120 and the first body 110 from unnecessarily heating up.

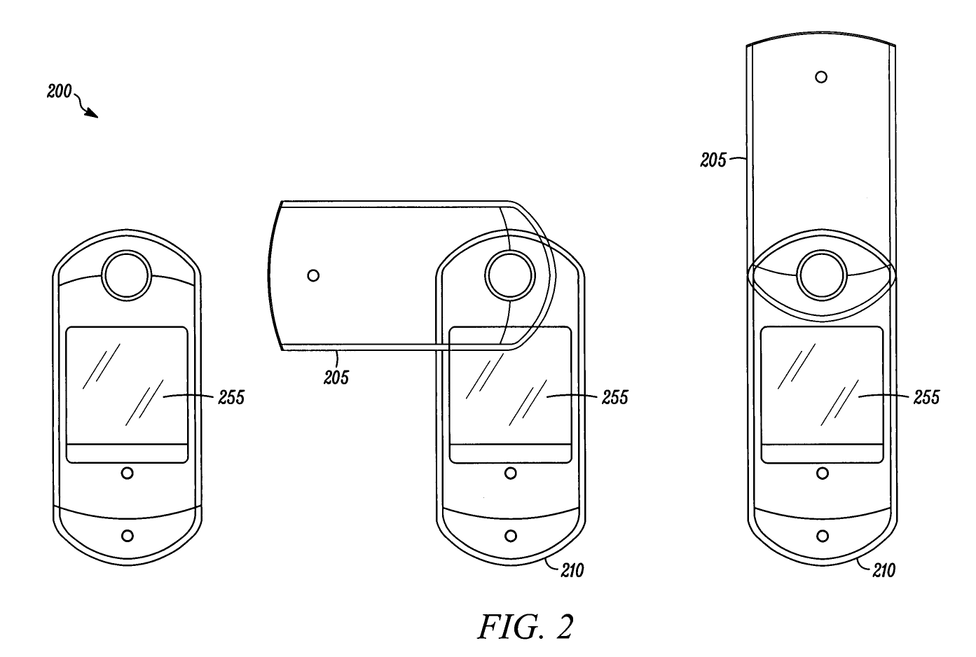

FIG. 2 shows an electronic device 200 with a virtual image display element according to a second embodiment. According to a second embodiment, an electronic device 200 has a display element 205 that can rotate up to a full 360° in a parallel plane relative to a first body 210. This embodiment has a liquid crystal display 255 in the first body 210 in addition to the display element 205. Furthermore, there can be an earpiece speaker mounted in the display element 205 or an earpiece speaker mounted in the first body 210 and ported through the display element 205.

Similar to that described with reference to FIG. 1, the electronic device further has a switch (not shown), which enables an image generation apparatus when the display element 205 has reached at least one predetermined position relative to the first body 210. The predetermined position of the display element 205 is a position with respect to the first body 210 that facilitates image generation in the display element 205. The significance of the predetermined position is that if the first body 210 and the display element 205 are misaligned, the light rays of the real image would not be properly incident into the display element 205. Similar to that described with reference to FIG. 1, the switch (not shown) disables the image generation apparatus when the display element 205 is not in the predetermined position relative to the first body 210. Disabling the image generation apparatus limits unnecessary use of the microdisplay as in FIG. 1, reduces power consumption, and also prevents the microdisplay and the first body 210 from unnecessarily heating up.

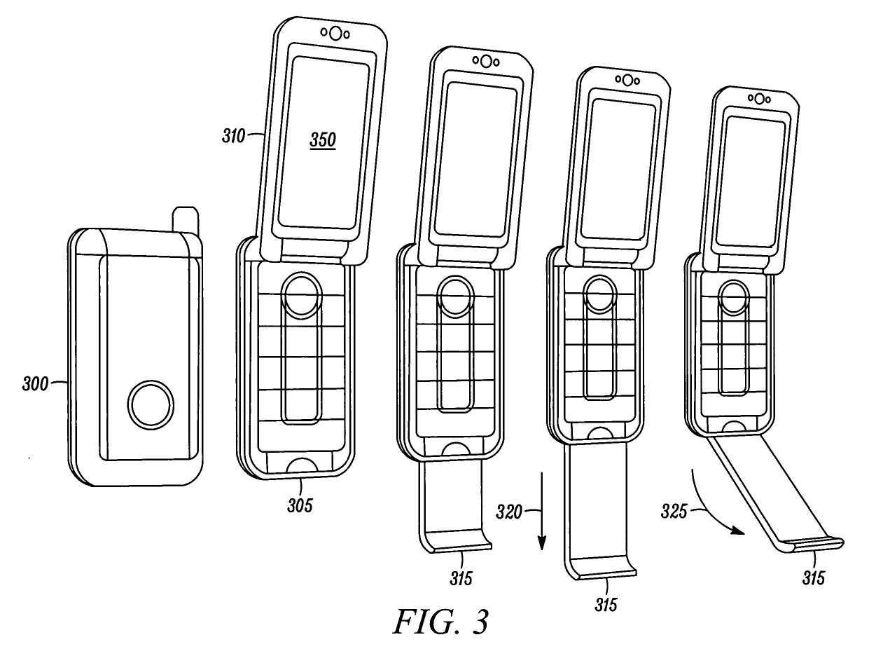

FIG. 3 shows a mobile communications device 300 having two bodies and a virtual display element according to a third embodiment. According to the third embodiment, an electronic device is a mobile communication device 300 that further includes a second body 310 moveably attached to a first body 305. In this embodiment, a mobile communications device 300 has a first body with an image generation apparatus and an optical system similar to that disclosed with reference to FIG. 1, and a second body 310 moveably attached to the first body 305, wherein the second body 310 provides a liquid crystal display 350. A display element 315 is moveably attached to the first body 305, and is capable of sliding in a parallel plane relative to the first body 305. When the display element 315 slides out to reach a predetermined position 320, the display element 315 is disposed such that it is capable of rotation 325 at an angle relative to the first body 305 to reach at least one alternate position.

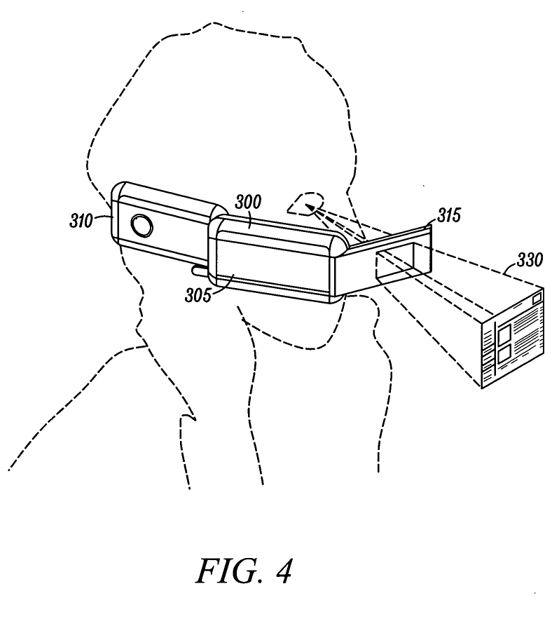

As shown in FIG. 4, the mobile communications device 300 allows a user to view an image at a near-to-eye distance with a large field-of-view 330 while simultaneously talking on the mobile communications device 300.

As previously described with reference to FIG. 1 and FIG. 2, the electronic device further includes a switch (not shown), which enables the image generation apparatus when the display element has reached at least one predetermined position relative to the first body. In this embodiment of the electronic device being a clamshell phone, a predetermined position occurs when the user is using the phone. In other words, the predetermined position is suited for a user talking on a mobile phone while viewing an image on the display element 315 as shown in FIG. 4.

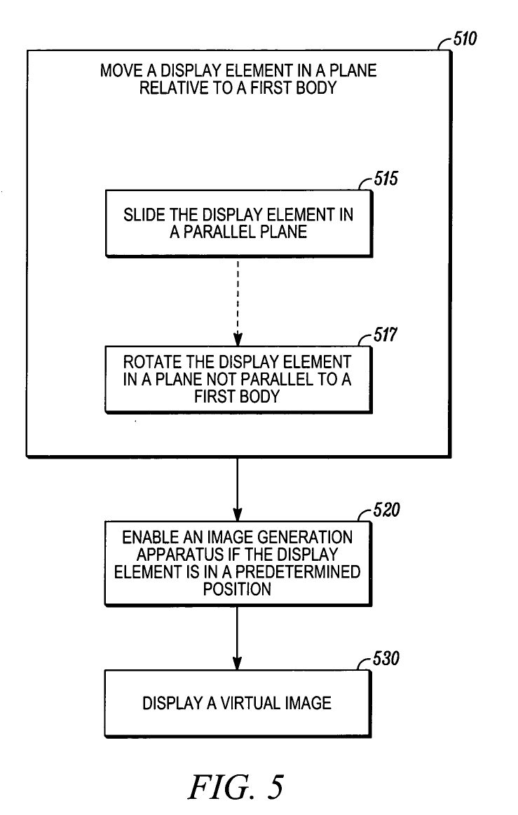

FIG. 5 shows a flowchart 500 depicting a method of virtual image generation in an electronic device with a display element. The electronic device 100, 200, 300 could be any of the embodiments previously described. The method includes moving the display element in at least one plane relative to a first body of the electronic device 510; and, enabling an image generation apparatus in the first body, when the display element is in a predetermined position 520. The method further includes displaying a virtual image, when the display element is in the predetermined position 530.

According to a further embodiment, the moving step 510 includes sliding the display element in a parallel plane relative to the first body 515. In another embodiment, the moving step further includes rotating the display element in a plane, which is relatively not parallel to the first body 517. The method further includes disabling the image generation apparatus when the display element is not in the predetermined position relative to the first body.

The various embodiments of the invention enable a user to enjoy an electronic device with enhanced image viewing capabilities. In an embodiment, the user is able to use a mobile communications device with a virtual image display or display element that provides a virtual image with a larger field-of-view without compromising on the compactness of the communications device. The user is also able to enjoy the flexibility of viewing the display in various positions, with a near-to-eye distance.

This disclosure is intended to explain how to fashion and use various embodiments in accordance with the invention rather than to limit the true, intended and fair scope and spirit thereof. The foregoing discussion is not intended to be exhaustive or to limit the invention to the precise forms disclosed. Modifications or variations are possible in the light of the above teachings. The embodiment(s) was chosen and described to provide the best illustration of the principles of the invention and practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. An electronic device comprising:
a first body having an image generation apparatus and an optical system; and,
a display element enabled to provide a virtual image, moveably attached to the first body such that the display element is capable of moving in at least one plane relative to the first body; and
a switch, enabling the image generation apparatus when the display element is in a predetermined position relative to the first body and disabling the image generation apparatus when the display element is not in the predetermined position relative to the first body.

2. The device of claim 1, wherein the display element comprises a substrate guided optical element.

3. The device of claim 1, wherein the optical system comprises a collimator.

4. The device of claim 1, wherein the optical system comprises a converging lens.

5. The device of claim 1, wherein the optical system comprises at least one reflective surface.

6. The device of claim 5, wherein the at least one reflective surface is a face of a prism.

7. The device of claim 1, wherein the display element can move in a plane parallel to the first body.

8. The device of claim 1, wherein the display element is disposed such that the display element can slide in a plane parallel with the first body.

9. The device of claim 8, wherein the display element can be rotated at an angle relative to the first body.

10. The device of claim 1, wherein the image generation apparatus comprises a microdisplay.

11. (canceled)

12. The device of claim 1, further comprising a second body having a liquid crystal display, hingeably attached to the first body.

13. The device of claim 12, wherein the display element can slide out from a rear of the first body in a plane parallel to the first body.

14. The device of claim 13, wherein the display element can slide out from the rear of the first body in the plane parallel to the first body to a predetermined position and rotate from the predetermined position to at least one alternate position relative to the first body.

15. The device of claim 12, wherein the display clement can slide out from the bottom of the first body in a plane parallel to the first body to a predetermined position.

16. The device of claim 15, wherein the display element can rotate from the predetermined position to at least one alternate position relative to the second body.

17. A method for virtual image generation in an electronic device having a display element, the method comprising steps of:
moving the display element in at least one plane relative to a first body of the electronic device; and,
enabling an image generation apparatus in the first body when the display element is in a predetermined position relative to the first body.

18. The method of claim 17, further comprising:
displaying a virtual image, when the display element is in the predetermined position.

19. The method of claim 17, further comprising:
disabling the image generation apparatus when the display element is not in the predetermined position.

20. The method of claim 17, wherein the moving step further comprises:
sliding the display element in a parallel plane relative to the first body.

21. The method of claim 17, wherein the moving step further comprises:
rotating the display element in a plane not parallel to the first body.
